(19) United States
(12) Patent Application Publication
(10) Pub. No.: US 2007/0149274 A1
(43) Pub. Date: Jun. 28, 2007

(54) GAMING MACHINE

(75) Inventor: Masatsugu KOBAYASHI, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/557,268

(22) Filed: Nov. 7, 2006

(30) Foreign Application Priority Data
Nov. 11, 2005 (JP) 2005-327402

(51) Int. Cl. A63F 13/00

(52) U.S. Cl. 463/20

(57) ABSTRACT

A gaming machine has variable display portions, a lottery unit, and a privilege giving unit. In the variable display portions, symbols are variably displayed. The lottery unit holds a lottery for determining which symbols will be stopped in the variable display portions. The privilege giving unit gives a player a privilege. The gaming machine further has a storage unit in which a history data item that indicates symbols stopped in the past is stored. The privilege giving unit gives a player a privilege based on symbols determined in a lottery by the lottery unit and on the history data item.

### CROSS REFERENCE TO RELATED APPLICATION

This application is based upon and claims the benefit of priority from the prior Japanese Patent Application No. 2005-327402, filed on Nov. 11, 2005, the entire contents of which are incorporated herein by reference.

### BACKGROUND OF THE INVENTION

1. Field of the Invention

The present invention relates to a gaming machine that variably displays symbols, stops the symbols based on a lottery result, and gives a player a privilege based on a form of the stopped symbols.

2. Description of Related Art

A gaming machine such as slot machines and pachi-slot machines starts variable display of symbols when a player inserts a game medium such as a medal into the machine and performs a predetermined operation. Based on a result of an internal lottery which is held inside a gaming machine, symbols are stopped. In a slot machine for example, predetermined symbols are displayed in a stopped state on a pay line, and a predetermined amount of game media is paid out based on a form of the stopped symbols. When the stopped symbols take a predetermined form, a player is allowed to play a bonus game such as a free game, which is more advantageous to the player than a base game is (see Japanese Patent Unexamined Publication No. 2001-87452).

In the gaming machine disclosed in the above-mentioned document, along with a player's operation on a start lever for starting a game, a random number generator and a random number sampling circuit hold a lottery for a form of stopped symbols, a privilege, and the like. Then, symbols determined based on a lottery result are stopped in three display areas, respectively, and a privilege corresponding to a form of the symbols thus displayed is given to the player. For example, when symbols of “7” are stopped in the three display areas, a privilege of “jackpot” is given.

### SUMMARY OF THE INVENTION

In the gaming machine disclosed in the above-mentioned document, one lottery is held in every game, and symbols are variably displayed and stopped according to the lottery so that whether a privilege should be given or not is determined. This allows a player an opportunity to stop a game and leave the gaming machine upon every one game. As a result, many players may stop their games even though they have played merely a small number of games.

For a game arcade in which a gaming machine is placed, it is desirable that a player keeps playing a game on the gaming machine for as long a time as possible. However, it is not desirable to merely bind a player to one gaming machine, because such binding may rather cause a player to avoid playing a game on the gaming machine. Therefore, such a gaming machine is of demand that is capable of motivating a player to keep playing for a long time.

An object of the present invention is to provide a gaming machine that can present new amusement by giving a privilege based on a history, thereby motivating a player to keep playing for a long time.

According to an aspect of the present invention, there is provided a gaming machine comprising variable display portions, a lottery unit, and a privilege giving unit. In the variable display portions, a plurality of symbols are variably displayed. The lottery unit holds a lottery for determining which symbols will be stopped in the variable display portions. The privilege giving unit gives a player a privilege. The gaming machine further comprises a storage unit in which a history data item that indicates symbols stopped in the past is stored. The privilege giving unit gives a player a privilege based on symbols determined in a lottery by the lottery unit and symbols indicated by the history data item.

In this aspect, when giving a privilege to a player, not only symbols determined in a lottery by the lottery unit but also a history data item for the past games are referred to. Accordingly, even though a player missed a privilege in the current game, he/she can still expect to obtain a privilege based on the history data item in the next and subsequent games. This can present new amusement by giving a privilege based on a history, thereby motivating a player to keep playing for a long time.

### BRIEF DESCRIPTION OF THE DRAWINGS

Other and further objects, features and advantages of the invention will appear more fully from the following description taken in connection with the accompanying drawings in which:

FIG. 1 is a perspective view of an appearance of a gaming machine according to an embodiment of the present invention;

FIG. 2 schematically shows columns of symbols that are put on outer surfaces of respective reels;

FIG. 3 is a block diagram showing a control system of the gaming machine;

FIG. 4 is a diagram explanatory of a lottery history storage area that is formed in a RAM provided on a mother board shown in FIG. 3;

FIG. 5 is a flowchart showing a main control program that is executed by the gaming machine;

FIG. 6 is a flowchart showing a main game processing;

FIG. 7 is a flowchart showing a lottery processing;

FIG. 8 is a table showing winning combinations, probabilities of the respective winning combinations, and payout numbers for the respective winning combinations;

FIG. 9 is a flowchart showing a reel rotation control processing;

FIGS. 10A and 10B are diagrams that schematically explain memory contents stored in the lottery history storage area;

FIG. 11 is a flowchart showing a bonus game processing;

FIG. 12 is a diagram that explains a number-of-free-games determination table that is used in the bonus game processing; and

FIG. 13 is a perspective view of an appearance of the gaming machine whose upper display panel has a history data indicator thereon.

### DESCRIPTION OF THE PREFERRED EMBODIMENTS

In the following, a certain preferred embodiment of the present invention will be described with reference to the accompanying drawings.

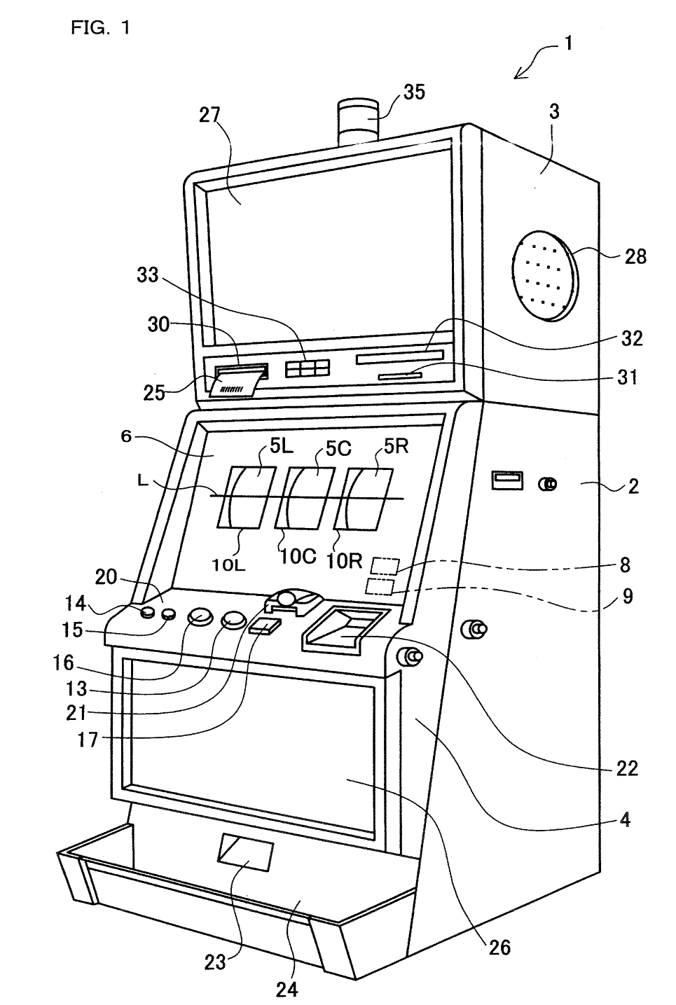

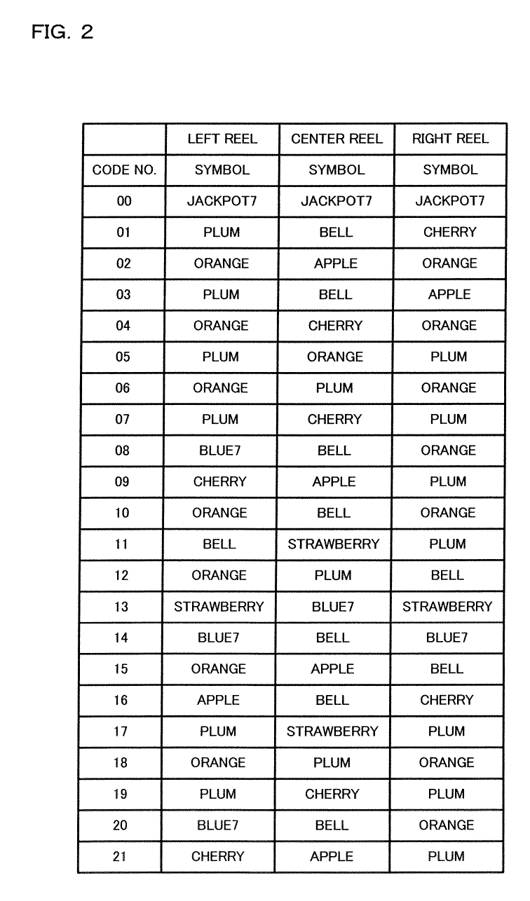

As shown in FIG. 1, a slot machine 1, as a gaming machine according to an embodiment of the present invention, has a cabinet 2, a top box 3 that is placed on the cabinet 2, and a main door 4 that is provided on a front face of the cabinet 2. Inside the cabinet 2, three rotatable reels 5L, 5C, and 5R are provided. A column of symbols, which includes twenty-two symbols (see FIG. 2), is painted on an outer surface of each of the reels 5L, 5C, and 5R.

On the main door 4, a lower display panel 6 having a transparent liquid crystal panel is provided in front of the respective reels 5L, 5C, and 5R. The lower display panel 6 functions as an image output device, and displays thereon various information about a game, effect images, and the like, during a game.

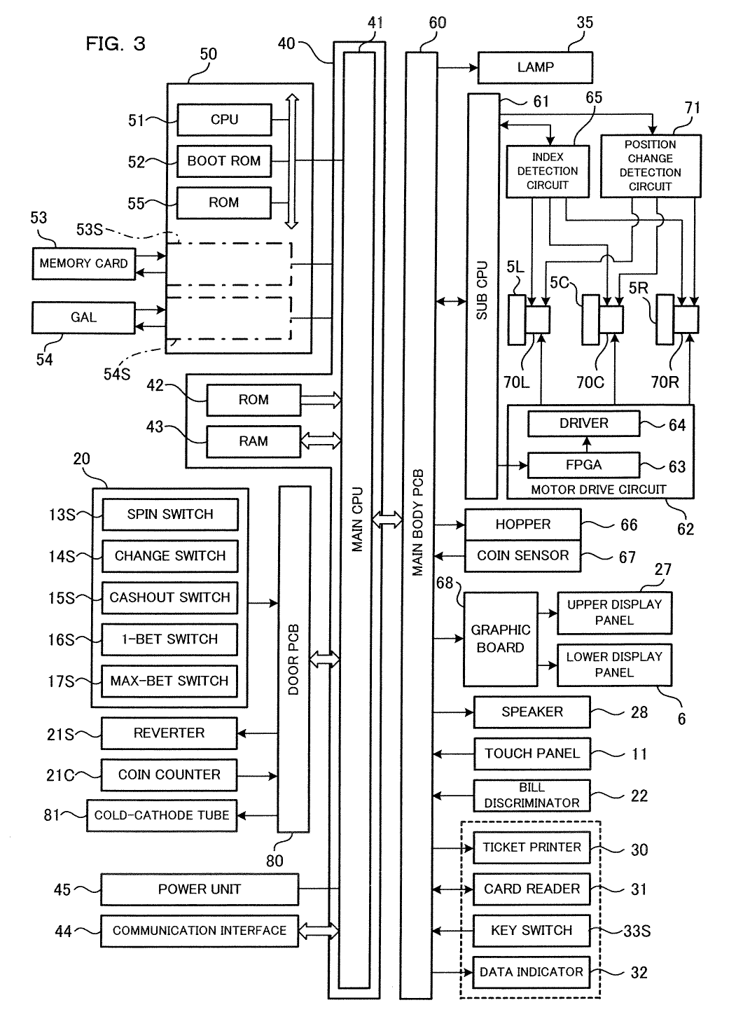

The lower display panel 6 has, on its front face, a touch panel 11 (see FIG. 3) though which a player inputs various commands.

The lower display panel 6 has a credit value indicator 8 and a payout number indicator 9. On the credit value indicator 8, a credit value a player is currently holding is indicated in the form of an image. On the payout number indicator 9, a credit value which will be paid out on condition that of symbols stopped on a pay line L make a predetermined combination is indicated in the form of an image.

Three see-through display windows 10L, 10C, and 10R are formed in the lower display panel 6. Through each of the display windows 10L, 10C, and 10R, three of the symbols painted on the outer surface of each of the reels 5L, 5C, and 5R are visible. One pay line L is formed on the lower display panel 6. The pay line L horizontally extends across the three display windows 10L, 10C, and 10R. When symbols stopped on the pay line L make a predetermined combination, a credit corresponding to the combination and to a betted credit value, i.e., a bet value, is basically paid out.

A control panel 20, a coin insertion slot 21, and a bill discriminator 22 are provided on a lower side of the lower display panel 6. The control panel 20 has buttons for a player to press in order to input commands concerning a game progress. Through the coin insertion, a coin, which functions as a game medium, is inserted into the cabinet 2.

A SPIN button 13, an EXCHANGE button 14, a CASHOUT button 15, a 1-BET button 16, and a MAX-BET button 17 are provided on the control panel 20. The SPIN button 13 is pressed in order to input a command to start rotation of the reels 5L, 5C, and 5R. The EXCHANGE button 14 is pressed when asking a staff of a game arcade for an exchange. The CASHOUT button 15 is pressed in order to input a command to pay out coins, the number of which is equivalent to a credit value a player is holding, through a coin payout opening 23 into a coin tray 24, or a command to output a later-described barcoded ticket 25. Here, one credit is equivalent to one coin.

The 1-BET button 16 is pressed in order to input a command to bet on a game one credit. The MAX-BET button 17 is pressed in order to input a command to bet on a game a maximum credit value bettable on one game. In this embodiment, the maximum credit value bettable on one game is 50 credits.

A reverter 21S and a coin counter 21C (see FIG. 3) are provided inside the coin insertion slot 21. The reverter 21S determines whether a coin inserted into the coin insertion slot 21 is proper one or not. Any coin different from a proper coin is ejected from the coin payout opening 23. The coin counter 21C detects a proper coin thus admitted, and counts the number of the coins.

The bill discriminator 22 determines whether a bill and a barcoded ticket 25 are proper ones or not, and receives proper ones into the cabinet 2. The bill inserted into the cabinet 2 is converted into coins, and a credit equivalent to the number of coins thus converted is added to the credit value a player is holding. A belly glass 26 on which a character of the slot machine 1 is painted is provided on a lower part of the front face of the main door 4, that is, provided below the control panel 20.

An upper display panel 27 having a liquid crystal panel is provided on a front face of the top box 3. Displayed on the upper display panel 27 are images showing game contents and game rules.

A speaker 28 which functions as a sound output device is provided on each side face of the top box 3. A ticket printer 30, a card reader 31, a data indicator 32, and a keypad 33 are provided under the upper display panel 27.

The ticket printer 30 is a printing device that prints on a ticket a barcode showing, in a coded form, data such as a credit value, time and date, and an identification number of the slot machine 1, and outputs a barcoded ticket 25 thus printed. A player makes another gaming machine read the barcoded ticket 25 thus outputted, to play a game in the gaming machine. A player alternatively exchanges the barcoded ticket 25 with goods at a predetermined section of the game arcade.

The card reader 31 reads data out of a smart card carried by a player, or writes data into the smart card. Stored in the smart card are history data of games a player has played, and the like. Data about coins, bills, or credits may be stored in the smart card. A magnetic stripe card may be employed instead of the smart card.

The data indicator 32 is formed of a fluorescent display or the like. Data read out by the card reader 31, data inputted by a player through the keypad 33, or the like are indicated on the data indicator 32. The keypad 33 is operated when inputting data or a command about issue of the barcoded ticket 25.

A lamp 35 is provided on an upper face of the top box 3. When an error occurs in the slot machine 1 or when the EXCHANGE button 14 is pressed, the lamp 35 lights in a predetermined lighting pattern.

Then, based on FIG. 2, a description will be given to symbols painted on the outer surfaces of the respective reels 5L, 5C, 5R, which are, during a game, variably displayed in a scrolling manner through the display windows 10L, 10C, and 10R of the lower display panel 6.

A column of symbols painted on the outer surface of each of the left reel 5L, the center reel 5C, and the right reel 5R is a combination of symbols of “BONUS 7”, “BLUE 7”, “BELL”, “CHERRY”, “STRAWBERRY”, “PLUMN”, “ORANGE”, and “APPLE”. On the surface of each of the reels 5L, 5C, and 5R, predetermined symbols are arranged in a predetermined order.

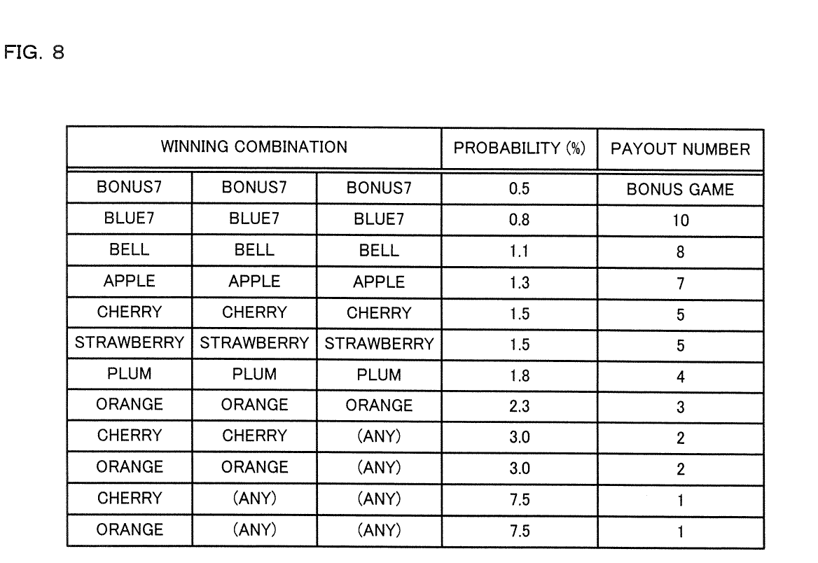

As shown in FIG. 8, when three of “BLUE 7”, “BELL”, “CHERRY”, “STRAWBERRY”, “PLUM”, “ORANGE”, or “APPLE” symbols are stopped on the pay line L, a credit value corresponding to a predetermined payout number is added to a credit value a player is holding. When one or two “CHERRY” or “ORANGE” symbols are stopped on the pay line L, a credit value corresponding to a predetermined payout number is, in accordance with the number of “CHERRY” or “ORANGE” symbols stopped, added to a credit value a player is holding. The “BONUS 7” symbol is a bonus-game trigger symbol. When three “BONUS 7” symbols are stopped on the pay line L, that is, when a win of “BONUS 7” is made, the game is shifted to a bonus game and a player is allowed to play the bonus game.

In the slot machine 1 of this embodiment, a condition for shifting to the bonus game is, in addition to a win of “BONUS 7”, that five or more “BONUS 7” symbols are stored in a lottery history storage area 46 which will be described later. A bonus game as a result of a win of the “BONUS 7” will be referred to as a “basic bonus game”. A bonus game as a result of five or more “BONUS 7” symbols being stored in the lottery history storage area 46 will be referred to as a “history bonus game”.

In the slot machine 1 of this embodiment, a predetermined number of free games, which mean games playable without a bet, can be played in a bonus game.

When the 1-BET button 16 or the MAX-BET button 17 is pressed and then the SPIN button 13 is pressed to thereby start a game, the columns of symbols painted on the reels 5L, 5C, and 5R as shown in FIG. 2 are, along with rotation of the reels 5L, 5C, 5R, displayed scrollingly from up to down within the display windows 10L, 10C, and 10R, respectively. After a predetermined period of time elapses, as the reels 5L, 5C, and 5R stop rotating, the columns of symbols are stopped in the display windows 10L, 10C, and 10R, respectively. Various wins have been set in advance based on combinations of symbols (see FIG. 8). When symbols stopped on the pay line L make a winning combination, a payout number associated with the winning combination is added to a credit value a player is holding.

On the other hand, when a game is shifted to the “basic bonus game” or the “history bonus game”, nothing is added to the credit value. That is, nothing is added to the credit value, not only when the win of “BONUS 7” is made, but also when a combination including one or two “CHERRY” or “ORANGE” symbols is made and a condition for shifting to the “history bonus game” is satisfied.

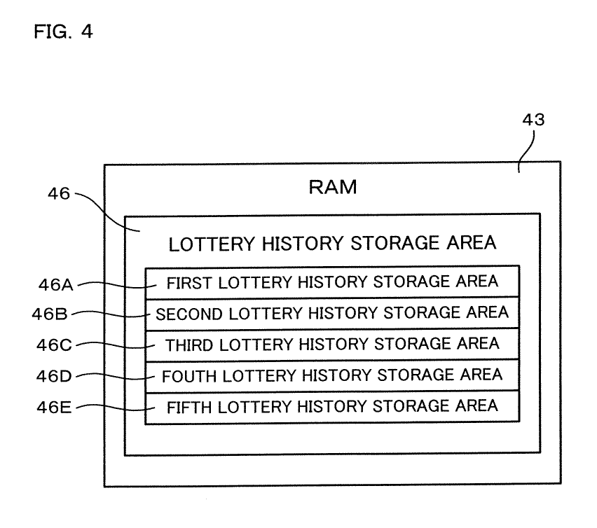

Next, a control system of the slot machine 1 will be described with reference to FIGS. 3 and 4.

As shown in FIG. 3, the control system of the slot machine 1 has a mother board 40 and a gaming board 50. The gaming board 50 includes a CPU 51, a ROM 55, a boot ROM 52, a card slot 53S, and an IC socket 54S. The CPU 51, the ROM 55, and the boot ROM 52 are connected with each other via an internal bus. A memory card 53 can be inserted into and pulled out of the card slot 53S. A GAL (General Array Logic) 54 can be inserted into and pulled out of the IC socket 54S.

The memory card 53 is a non-volatile memory such as Compact Flash (registered trademark). A game program and a game system program are stored in the memory card 53. The game program includes a lottery program which is a program for determining a code number associated with a symbol which will be stopped on the pay line L. The lottery program includes symbol weighting data, which correspond to respective payout rates such as 80%, 84%, and 88%. The symbol weighting data indicate, with respect to each of the three reels 5L, 5C, and 5R, a correspondence between a code number of a symbol (see FIG. 2) and one or more random numbers belonging to a predetermined number range. That is, a code number of one symbol corresponds to one or more random numbers. A random number is sampled by a lottery, to determine which symbol will be stopped. A payout rate is determined based on payout rate setting data which is outputted from the GAL 54.

The card slot 53S is connected to the mother board 40 via an IDE bus. When the memory card 53, which is once pulled out of the card slot 53S and then overwritten with another game program and another game system program, is inserted into the card slot 53S again, a kind of game or contents of a game playable in the slot machine 1 is/are changed. Alternatively, it is also possible to prepare several memory cards 53 in which different game programs and different game system programs are stored in order that a kind of game or contents of a game playable in the slot machine 1 can be changed by replacing one memory card 53 with another memory card 53.

The game program includes a program for a game progress, a program for producing a bonus game, image data and sound data which are outputted during a game, image data and sound data which work as notification data, and the like.

The GAL 54 is a kind of PLD (Programmable Logic Device) having a fixed-OR logic array. The GAL 54 has input ports and output ports. When predetermined data is inputted into the input ports, the GAL 54 outputs from the output ports data corresponding to the inputted data. The above-mentioned payout rate setting data is outputted from the output ports.

The IC socket 54S is connected to the mother board 40 via a PCI bus. When the GAL 54, which is once pulled out of the IC socket 54S and then has a program stored therein overwritten, is mounted to the IC socket 54S again, payout rate setting data is changed. Alternatively, it is also possible to prepare several GALs 54 in which different programs are stored in order that payout rate setting data can be changed by replacing one GAL 54 with another GAL 54.

The CPU 51, the ROM 55, and the boot ROM 52 are connected to the mother board 40 via the PCI bus. The PCI bus carries a signal between the mother board 40 and the gaming board 50, and besides supplies power from the mother board 40 to the gaming board 50. Country identification information and an authentication program are stored in the ROM 55. A preliminary authentication program, a program for the CPU 51 to boot up the preliminary authentication program, which means a boot code, and the like are stored in the boot ROM 52.

The authentication program is a program for authenticating a game program and a game system program. That is, the authentication program is a falsification check program. The authentication program is written along a procedure of falsification check on a target game program and a target game system program. The preliminary authentication program is a program for authenticating the authentication program. The preliminary authentication program is written along a procedure of falsification check on a target authentication program.

The mother board 40 is a general-purpose mother board on the market, that is, a printed wiring board mounted with basic components of a personal computer. The mother board 40 has a main CPU 41, a ROM 42, a RAM 43, and a communication interface 44.

The ROM 42 is a memory device such as a flash memory. A program such as a BIOS, which is executed by the main CPU 41, and permanent data are stored in the ROM 42. When the main CPU 41 executes the BIOS, predetermined peripheral units are subjected to an initialization process, and a game program and a game system program that are stored in the memory card 53 start to be captured via the gaming board 50. The ROM 42 may be one capable or incapable of rewriting its memory contents.

Data and a program, which are used when the main CPU 41 operates, are stored in the RAM 43. To be more specific, an authentication program, a game program, and a game system program which are read out of the gaming board 50, and various information such as a credit value a player is currently holding are stored in the RAM 43.

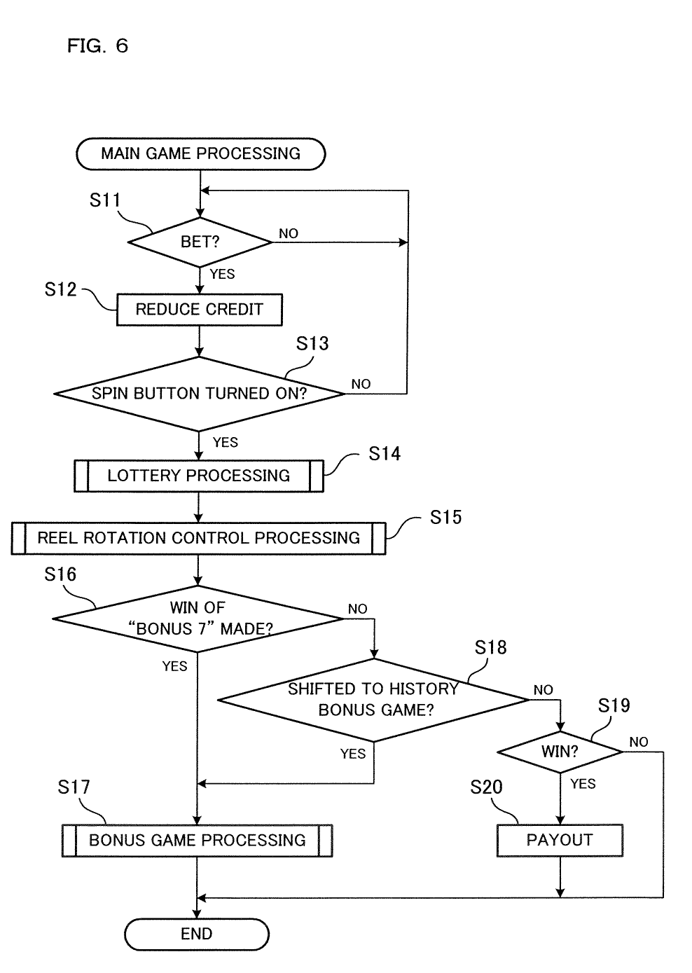

The lottery history storage area 46 (see FIG. 4) is formed in the RAM 43. Stored in the lottery history storage area 46 are results of the latest five lotteries held in a later-described lottery processing (see S14 of FIG. 6). Five storage areas of a first lottery history storage area 46A, a second lottery history storage area 46B, a third lottery history storage area 46C, a fourth lottery history storage area 46D, and a fifth lottery history storage area 46E are formed in the lottery history storage area 46. Lottery history data, which means data of symbols that were stopped on the respective reels 5L, 5C, and 5R in one game, and data of the total number of games played are stored in each of the five storage areas.

The communication interface 44 communicates, through a communication line, with a server placed in the game arcade.

A main body PCB 60 and a door PCB 80 are respectively connected to the mother board 40 via USBs. A power unit 45 is also connected to the mother board 40. When power is supplied from the power unit 45 to the mother board 40, the main CPU 41 of the mother board 40 is started, and power is supplied through the PCI bus to the gaming board 50 so that the CPU 51 is started.

Equipments or devices that generate an input signal to be inputted to the main CPU 41, and equipments or devices whose operations are controlled in accordance with a control signal outputted from the main CPU 41 are connected to the main body PCB 60 and the door PCB 80, respectively. Based on an input signal inputted into the main CPU 41, the main CPU 41 executes a game program and a game system program stored in the RAM 43. Then, the main CPU 41 executes a predetermined computing processing, and stores a result of the processing into the RAM 43, or transmits a control signal to the equipments or devices.

The lamp 35, a sub CPU 61, a hopper 66, a coin sensor 67, a graphic board 68, the speaker 28, the touch panel 11, the bill discriminator 22, the ticket printer 30, the card reader 31, a key switch 33S, and the data indicator 32 are connected to the main body PCB 60. The lamp 35 lights in a predetermined pattern based on a control signal outputted from the main CPU 41.

The sub CPU 61 controls rotating and stopping of the reels 5L, 5C, and 5R. A motor drive circuit 62 is connected to the sub CPU 61. Stepping motors 70L, 70C, and 70R are connected to the motor drive circuit 62. The stepping motors 70L, 70C, and 70R are for rotating the respective reels 5L, 5C, and 5R. The stepping motors 70L, 70C, and 70R are stepping motors of 1-2 phase excitation type. The motor drive circuit 62 includes an FPGA (Field Programmable Gate Array) 63 and a driver 64. The FPGA 63 is an electronic circuit such as an LSI (Large Scale Integration) capable of programming. The FPGA 63 functions as a control circuit for the stepping motors 70L, 70C, and 70R. The driver 64 functions as an amplifier circuit for a pulse which will be inputted into the stepping motors 70L, 70C, and 70R.

An index detection circuit 65 and a position change detection circuit 71 are connected to the sub CPU 61. The index detection circuit 65, which detects a position, e.g., a reference point, of the rotating reels 5L, 5C, and 5R, can detect out-of-step of the reels 5L, 5C, and 5R.

The position change detection circuit 71 detects a change of a stopping position of the reels 5L, 5C, and 5R after rotation of the reels 5L, 5C, and 5R is stopped. For example, in a case where a winning combination of symbols is actually not be made but nevertheless a player forcibly changes a stopping position so as to make a winning combination of symbols, the position change detection circuit 71 detects a change of a stopping position of the reels 5L, 5C, and 5R.

The hopper 66 is placed within the cabinet 2, and pays out a predetermined number of coins through the coin payout opening 23 into the coin tray 24 based on a control signal outputted from the main CPU 41. The coin sensor 67 is provided inside the coin payout opening 23, and outputs an input signal into the main CPU 41 when detecting a predetermined number of coins being paid out through the coin payout opening 23.

The graphic board 68 controls an image display on the upper display panel 27 and the lower display panel 6, based on a control signal outputted from the main CPU 41. The credit value indicator 8 in the lower display panel 6 indicates a credit value a player is holding, which is stored in the RAM 43. The payout number indicator 9 indicates a credit value which will be paid out. The graphic board 68 has a VDP (Video Display Processor), a video RAM, and the like. The VDP generates image data based on a control signal outputted from the main CPU 41. Image data generated by the VDP is temporarily stored in the video RAM. Data used by the VDP for generating image data is included in a game program that has been read out of the memory card 53 and stored in the RAM 43.

When admitting a proper bill, the bill discriminator 22 outputs to the main CPU 41 an input signal that is based on the amount of the bill. When admitting a proper barcoded ticket 25, the bill discriminator 22 outputs to the main CPU 41 an input signal that is based on the number of coins recorded on the barcoded ticket 25. Based on the input signals, the main CPU 41 stores into the RAM 43 a credit value corresponding to the amount of bill or ticket 25.

Based on a control signal outputted from the main CPU 41, the ticket printer 30 prints on a ticket a barcode showing, in a coded form, data such as a credit value stored in the RAM 43, time and date, and an identification number of the slot machine 1, and outputs a barcoded ticket 25 thus printed. The card reader 31 reads data out of a smart card and transmits the data to the main CPU 41, or writes data into a smart card based on a control signal outputted from the main CPU 41. The key switch 33S is provided inside the keypad 33. When the keypad 33 is operated by a player, the key switch 33S outputs a predetermined input signal to the main CPU 41. Based on a control signal outputted from the main CPU 41, the data indicator 32 indicates data read out by the card reader 31, data inputted by a player using the keypad 33, or the like.

The control panel 20, the reverter 21S, the coin counter 21C, and a cold-cathode tube 81 are connected to the door PCB 80. The control panel 20 includes a SPIN switch 13S provided within the SPIN button 13, an EXCHANGE switch 14S provided within the EXCHANGE button 14, a CASHOUT switch 15S provided within the CASHOUT button 15, a 1-BET switch 16S provided within the 1-BET button 16, and a MAX-BET switch 17S provided within the MAX-BET button 17. When a button corresponding to each switch is pressed by a player, the switch outputs an input signal to the main CPU 41.

The reverter 21S and the coin counter 21C are provided inside the coin insertion slot 21. The reverter 21S determines whether a coin inserted into the coin insertion slot 21 is proper one or not, and distributes a coin determined as proper to a cash box (not shown) that is placed in the slot machine 1 or to the hopper 66. When the hopper 66 is filled with coins, the proper coin is distributed to the cash box. When the hopper 66 is not filled with coins, the proper coin is distributed to the hopper 66. An improper coin is ejected from the coin payout opening 23. The coin counter 21C detects a proper coin thus admitted, and outputs an input signal to the main CPU 41.

The cold-cathode tube 81 functioning as a backlight is provided on a back side of the lower display panel 6 and on a back side of the upper display panel 27. The cold-cathode tube 81 is lighted based on a control signal outputted from the main CPU 41.

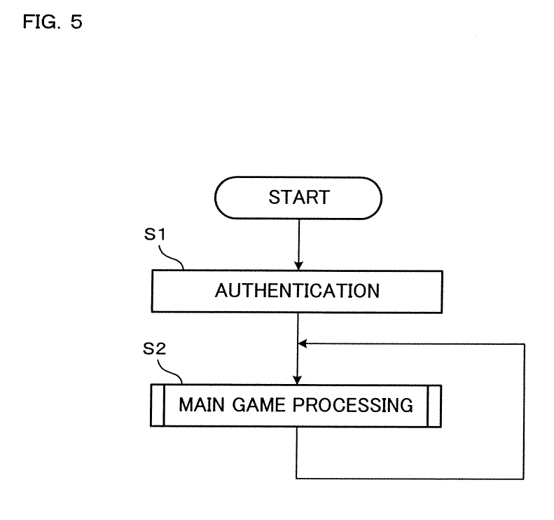

Next, a main control program that is executed by the slot machine 1 will be described with reference to FIG. 5. It is presupposed that, in the slot machine 1, the memory card 53 has already been inserted into the card slot 53S of the gaming board 50 and the GAL 54 has already been mounted to the IC socket 54S.

First, when the power unit 45 is powered up, the mother board 40 and the gaming board 50 are booted up, and authentication is performed individually in the mother board 40 and in the gaming board 50 (S1).

To be more specific, in the gaming board, the CPU 51 reads out the preliminary authentication program that is stored in the boot ROM 52. In accordance with the preliminary authentication program thus read out, the CPU 51 authenticates that the authentication program is not falsified, before the mother board 40 reads out the authentication program.

In the mother board 40, the main CPU 41 executes the BIOS that is stored in the ROM 42, and expands in the RAM 43 compressed data included in the BIOS. The main CPU 41 executes the BIOS thus expanded in the RAM 43. The main CPU 41 also checks and initializes various peripheral units. Then, the main CPU 41 reads out the authentication program stored in the ROM 55, and authenticates that a game program and a game system program stored in the memory card 53 that is inserted into the card slot 53S are not falsified. When authentication is completed normally, the main CPU 41 writes into the RAM 43 the game program and the game system program thus authenticated, and also writes into the RAM 43 payout rate setting data outputted from the GAL 54 and country identification information stored in the ROM 55.

Then, the main CPU 41 sequentially reads out of the RAM 43 the game program and the game system program authenticated in Si. The main CPU 41 executes these programs, to execute a main game processing (S2). By executing the main game processing, one game is played in the slot machine 1. The main game processing is executed repeatedly as long as the slot machine 1 is supplied with power.

Next, a main game processing (S2) will be described with reference to FIG. 6. Programs of respective processings shown in FIGS. 6, 7, 9, and 11 are stored in the ROM 42 or the RAM 43 and executed by the main CPU 41.

When the main game processing is started, the main CPU 41 executes a predetermined initial setting. Then, the main CPU 41 determines whether a player has made a bet or not, based on whether an input signal, which is outputted from the 1-BET switch 16S at the time when the 1-BET button 16 is pressed, or an input signal, which is outputted from the MAX-BET switch 17S at the time when the MAX-BET button 17 is pressed, is received or not (S11).

When the main CPU 41 determines that a player has made a bet (S11: YES), a credit value the player is holding, which is stored in the RAM 43, is reduced by a bet value (S12). When the credit value stored in the RAM 43 is smaller than the bet value, the credit value stored in the RAM 43 is not reduced and the processing returns to S11. When the main CPU 41 determines that a player has not made a bet (S11: NO), the CPU 41 waits until the player makes a bet. During a waiting time, a demo screen, for example, is displayed on the lower display panel 6.

Next, the main CPU 41 determines whether the SPIN button 13 is turned ON or not, based on whether an input signal outputted from the SPIN switch 13S is received or not (S13). When the main CPU 41 determines that the SPIN button 13 is not turned ON (S13: NO), the main CPU 41 cancels the reduction of the credit value which has been performed in S12, and then the processing returns to S11.

When it is determined that the SPIN button 13 is turned ON (S13: YES), the main CPU 41 executes a lottery processing (S14). In the lottery processing, the main CPU 41 executes a lottery program stored in the RAM 43, to determine a code number for each of the reels 5L, 5C, and 5R.

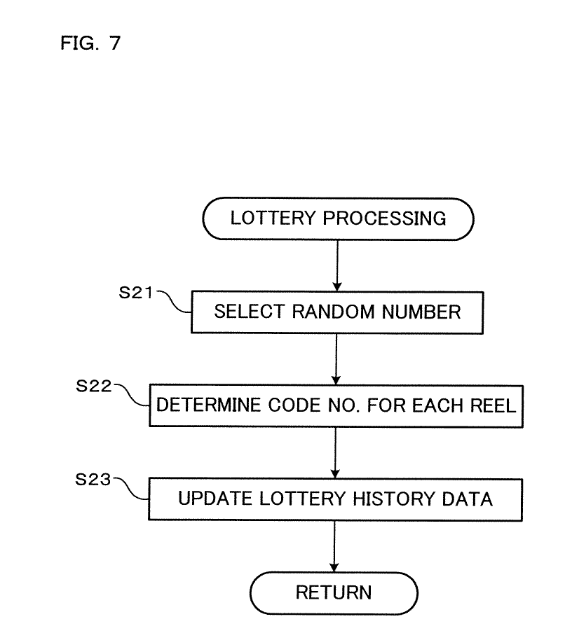

Here, the lottery processing (S14) will be described with reference to FIG. 7.

First, the main CPU 41 executes a random number generating program that is included in the lottery program, to thereby select, among a number range of 0 to 255, a random number corresponding to each of the three reels 5L, 5C, and 5R (S21). In this embodiment, a so-called software random number is adopted, and a random number is generated on a program. However, a so-called hardware random number, by which a random number is sampled out of a random number generator, may be adopted instead of the software random number.

Next, the main CPU 41 refers to symbol weighting data corresponding to the payout rate setting data that is outputted from the GAL 54 and stored in the RAM 43, and determines code numbers for the respective reels 5L, 5C, and 5R (see FIG. 2) based on three random numbers selected in S21 (S22). The main CPU 41 stores into the RAM 43 the code numbers for the respective reels 5L, 5C, and 5R thus determined, and then the processing proceeds to S23.

As described above, the code numbers are associated with the symbols, respectively. Accordingly, by determining code numbers for the respective reels 5L, 5C, and 5R, a combination of symbols which will be stopped on the pay line L is determined. For example, when code numbers for the respective reels 5L, 5C, and 5R are determined as “00”, “00”, and “00”, a win of “BONUS 7” will be made.

Then, the main CPU 41 writes, into one of the first to fifth lottery history storage areas 46A to 46E of the lottery history storage area 46, lottery history data which mean the code numbers for the respective reels 5L, 5C, and 5R determined in S22 and data of the total number of games played, thus updating memory contents of the storage area (S23). The total number of game played means the number of games that have been played during a period from the power-up or the last reset of the lottery history data to the present. Therefore, by referring to the data of the total number of games played that are stored in the first to fifth lottery history storage areas 46A to 46E, the oldest lottery history data can be identified.

In S23, the main CPU 41 firstly refers to the data of the total number of games played that are stored in the first to fifth lottery history storage areas 46A to 46E, and identifies a storage area that stores therein the oldest lottery history data. Then, the lottery history data obtained from the current lottery is overwritten into the identified storage area. As a result, memory contents of the lottery history storage area 46 can be updated into the latest five lottery history data including the data of current game. After S23, the lottery processing ends, and the processing proceeds to S15 of FIG. 6.

Here, with reference to FIG. 8, a description will be given to winning combinations and payout numbers for the winning combinations in the base game and in the bonus game.

Payout numbers shown in FIG. 8 are under the condition that a bet value is “1”. Accordingly, when a bet value is “1”, a value of the payout number shown in FIG. 8 is added to a credit. When a bet value is “2” or more, a value obtained by multiplying a value of the payout number shown in FIG. 8 by the bet value is added to a credit.

Probabilities of winning combinations shown in FIG. 8 are under the condition that a payout rate in the base game is 88%. The probability of a winning combination shown in FIG. 8 indicates a probability that, when code numbers for the respective reels 5L, 5C, and 5R are determined based on three random numbers selected in S21 and with reference to the symbol weighting data corresponding to the payout rate of 88%, a winning combination corresponding to the code numbers will be made. That is, although symbols are determined based on the random numbers selected in S21, a win corresponding to a combination of the determined symbols is not always made.

For example, a probability of win of a “BONUS 7” is 0.5%. When this win is made, three “BONUS 7” symbols are stopped on the pay line L, and the game is shifted to a basic bonus game. A probability of win of a “BLUE 7” is 0.8%. When this win is made, three “BLUE 7” symbols are stopped on the pay line L, and 10 credits are paid out per one bet. A probability of win of a “BELL” is 1.1%. When this win is made, three “BELL” symbols are stopped on the pay line L, and 8 credits are paid out per one bet. For each of the other combination of symbols shown in FIG. 8, a probability of win and a payout number are set. When a combination of symbols that is not shown in FIG. 8 is made, it means a loss and therefore no credit is paid out.

Referring to FIG. 6 again, in S15, the main CPU 41 executes a reel-rotation control processing. The reel rotation control processing is a processing for starting rotation of all the reels 5L, 5C, and 5R and then stopping the rotation of the reels 5L, 5C, and 5R so that symbols associated with the code numbers that have been determined in S22 of FIG. 7 and stored in the RAM 43 are stopped on the pay line L.

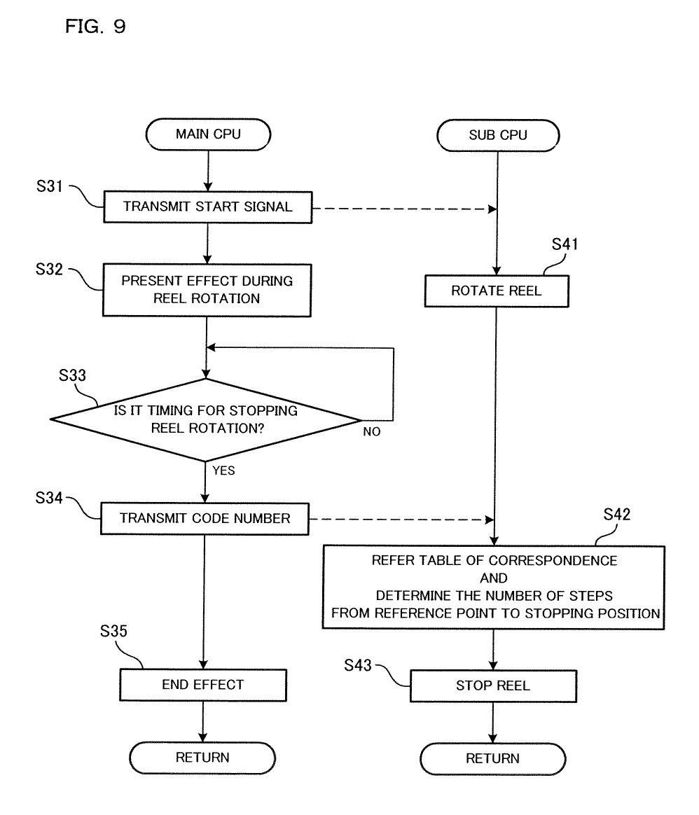

Here, the reel rotation control processing (S15) will be described with reference to FIG. 9. This processing is executed by the main CPU 41 and the sub CPU 61.

First, the main CPU 41 transmits to the sub CPU 61 a start signal for starting rotation of the reels (S31). Upon receiving the start signal from the main CPU 41, the sub CPU 61 makes the reels start rotating (S41). At this time, the sub CPU 61 supplies a pulse to the motor drive circuit 62 (see FIG. 3). The pulse is amplified by the driver 64, and supplied to the stepping motors 70L, 70C, and 70R. Consequently, the stepping motors 70L, 70C, and 70R are rotated, and the reels 5L, 5C, and 5R are rotated accordingly. In the stepping motors 70L, 70C, and 70R, which are of 1-2 phase excitation type, a step angle is 0.9 degrees and the number of steps per rotation is 400. Therefore, when 400 pulses are supplied to the stepping motors 70L, 70C, and 70R, the reels 5L, 5C, and 5R make one rotation.

At the time when the reels 5L, 5C, and 5R are started to rotate, the sub CPU 61 supplies a low-frequency pulse to the motor drive circuit 62. Then, the sub CPU 61 gradually increases a pulse frequency. As the pulse frequency is increased, a rotational speed of the reels 5L, 5C, and 5R becomes higher. After a predetermined period of time elapses, the sub CPU 61 keeps the pulse frequency constant so that the reels 5L, 5C, and 5R rotate at a constant speed.

Each code number is associated with the number of steps from a reference point on the reel to the symbol corresponding to the code number. Therefore, upon detecting the reference point, pluses indicating the number of steps, which is associated with the code number, are supplied to the motor drive circuit 62. Thereby, the symbol associated with the code number is stopped on the pay line L.

After S31, the main CPU 41 presents an effect during reel rotation (S32). More specifically, for a time period determined depending on a result of the lottery processing (FIG. 7), e.g., for three seconds, an image is displayed on the lower display panel 6 and/or sound is outputted from the speaker 28, for example.

Next, the main CPU 41 determines whether it is a timing for stopping the rotation of the reels 5L, 5C, and 5R, or not (S33). The timing for stopping the rotation of the reels 5L, 5C, and 5R means a time point a minimum time required for stopping the rotation of the reels 5L, 5C, and 5R before the effect during reel rotation finishes. The minimum time required for stopping the rotation of the reels 5L, 5C, and 5R is determined in advance.

When the main CPU 41 determines that it is not the timing for stopping the rotation of the reels 5L, 5C, and 5R (S33: NO), the main CPU 41 continues presenting the effect during reel rotation. When the main CPU 41 determines that it is the timing for stopping the rotation of the reels 5L, 5C, and 5R (S33: YES), the main CPU 41 transmits to the sub CPU 61 the code number that is stored in the RAM 43 (S34). Then, the main CPU 41 ends the effect during reel rotation (S35).

When receiving the code number from the main CPU 41, the sub CPU 61 refers to a table of correspondence between the number of steps and each code number, which is stored in a ROM (not shown) of the sub CPU 61. Thus, the sub CPU 61 determines the number of steps from a reference point to a stopping position (S42).

Then, the sub CPU 61 stops the reels 5L, 5C, and 5R (S43). More specifically, the sub CPU 61 detects reference points of the respective reels 5L, 5C, and 5R. At a timing of this detection, the sub CPU 61 supplies, to the motor drive circuit 62, pulses indicating the number of steps determined in S42. Then, the sub CPU 61 stops supplying the pulses. As a result, symbols corresponding to the lottery result are stopped on the pay line L.

Referring to FIG. 6 again, after S15, the main CPU 41 determines whether the win of “BONUS 7” has been made or not (S16). When the main CPU 41 determines that the win of “BONUS 7” has been made (S16: YES), then the main CPU 41 reads a bonus game processing program out of the RAM 43, and executes a later-described bonus game processing (S17). After S17, the main CPU 41 ends the main game processing.

When the main CPU 41 determines that the win of “BONUS 7” has not been made (S16: NO), the processing proceeds to S18. In S18, the main CPU 41 refers to the lottery history storage area 46 and determines, based on whether five or more “BONUS 7” symbols are stored or not, whether a condition for shifting to the “history bonus game” is satisfied or not. When five or more “BONUS 7” symbols are stored in the lottery history storage area 46, that is, when a condition for shifting to the “history bonus game” is satisfied (S18: YES), the processing proceeds to S17. When a condition for shifting to the “history bonus game” is not satisfied (S18: NO), the processing proceeds to S19.

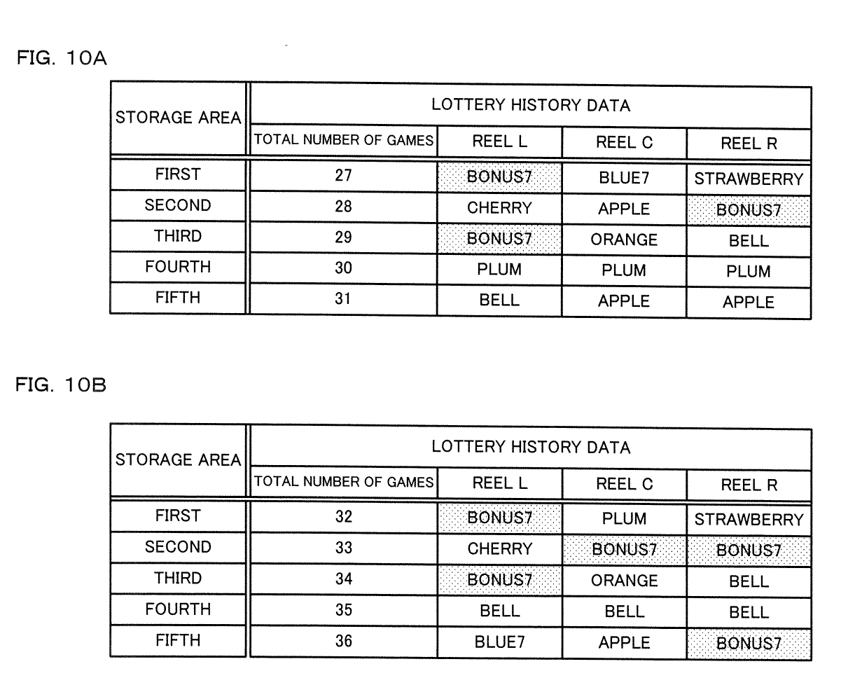

Here, the condition for shifting to the “history bonus game” will be described in more detail with reference to FIGS. 10A and 10B. As described above, data of symbols that were stopped on the respective reels 5L, 5C, and 5R in one game, and data of the total number of games played are stored in each of the first to fifth lottery history storage areas 46A to 46E of the lottery history storage area 46.

FIG. 10A shows memory contents of the lottery history storage area 46 in a case where 31 games have been played in total from the power-up or the last reset of the lottery history data. At this time, lottery history data for 27th to 31st games are stored in the respective storage areas of the lottery history storage area 46, and three “BONUS 7” symbols are stored. In this case, therefore, the condition for shifting to the “history bonus game” is not satisfied, and the processing proceeds to S19.

FIG. 10B shows memory contents of the lottery history storage area 46 in a case where 36 games have been played in total from the power-up or the last reset of the lottery history data. At this time, lottery history data for 32nd to 36th games are stored in the respective storage areas of the lottery history storage area 46, and five “BONUS 7” symbols are stored. In this case, therefore, the condition for shifting to the “history bonus game” is satisfied, and the processing proceeds to S17.

Referring to FIG. 6 again, in S19, the main CPU 41 determines, based on a combination of symbols stopped on the pay line L, whether any win other than the win of “BONUS 7” has been made or not. When the main CPU 41 determines that any win other than the win of “BONUS 7” has been made (S19: YES), then the main CPU 41 adds, to a credit value a player is holding, a credit value that corresponds to the bet value and to a payout number of the win (S20). When the CASHOUT button 15 is pressed, the credit thus added is paid out in the form of coins equivalent to the credit value. Alternatively, the credit may be paid out in the form of barcoded ticket 25. After S20, or when the main CPU 41 determines that no win has been made (S19: NO), the main game processing ends.

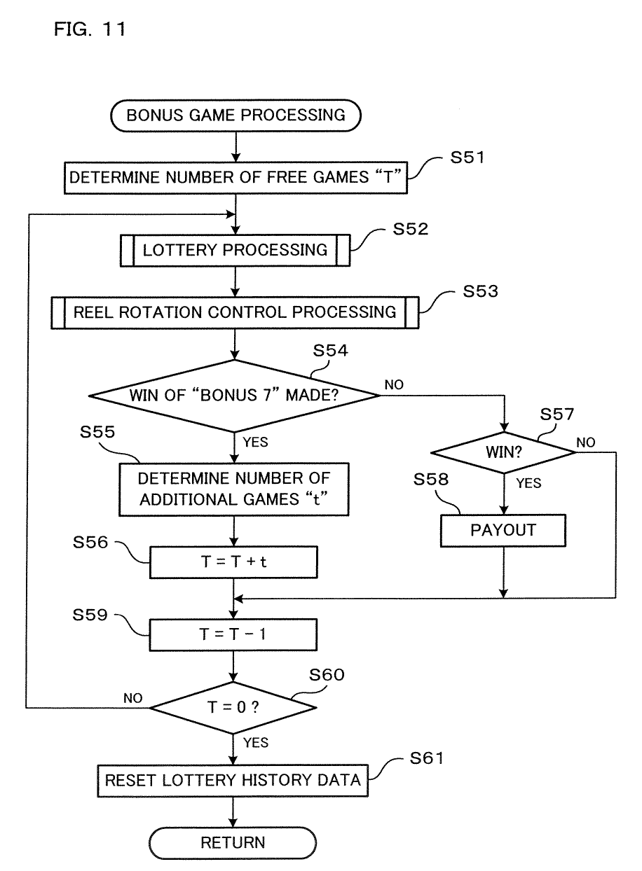

Next, a bonus game processing (S17) will be described with reference to FIG. 11. This processing is executed by the main CPU 41 and the sub CPU 61.

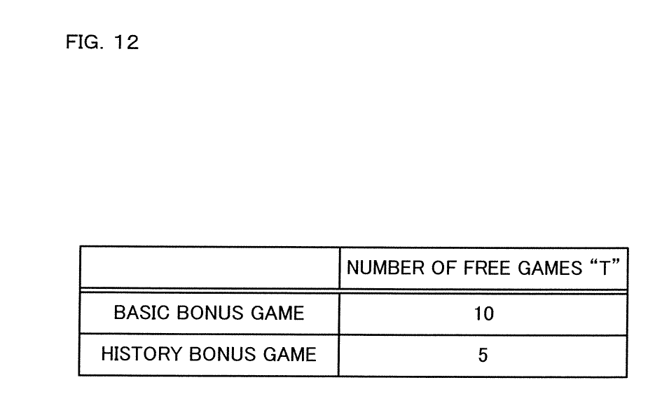

First, the main CPU 41 refers to a number-of-free-games determination table (FIG. 12) that is stored in the ROM 42, to determine the number of free games “T” which will be played in the bonus game (S51). As shown in FIG. 12, in the number-of-free-games determination table, the number of free games “T” is predetermined with respect to each of the “basic bonus game” and the “history bonus game” Thus, the main CPU 41 determines which condition for shifting to the “basic bonus game” or the “history bonus game” has been satisfied, based on memory contents of the lottery history storage area 46. Then, based on a result of this determination, the main CPU 41 determines the number of free games “T”.

For example, when the condition for shifting to the “basic bonus game” has been satisfied, the number of free games “T” is determined as “10”. When the condition for shifting to the “history bonus game” has been satisfied, the number of free games “T” is determined as “5”. Then, data showing the number of free games “T” playable in the bonus game is stored into the RAM 43, and the processing is shifted to S52.

Subsequently, the main CPU 41 executes a lottery processing (S52) and a reel rotation control processing (S53). The lottery processing (S52) is substantially the same as the lottery processing (S14) described above with reference to FIG. 7. The reel rotation control processing (S53) is substantially the same as the reel rotation control processing (S15) described above with reference to FIG. 9. Thus, details of S52 and S53 have already been described, and therefore a description thereof is omitted. The lottery processing (S52) differs from the lottery processing (S14) only in that updating of the lottery history (S23) is not performed. In the bonus game processing, therefore, a player is given a privilege due to the win of “BONUS 7”, payouts due to the other wins, or the like, but a privilege due to memory contents of the lottery history storage area 46 is not given.

After S53, the main CPU 41 determines whether the win of “BONUS 7” has been made on the pay line L or not (S54). When the main CPU 41 determines that the win of “BONUS 7” has been made (S54: YES), then the number of additional games “t” is newly determined based on a random number obtained by executing a random number generating program that is included in the lottery program stored in RAM 43 (S55). For example, the number of additional games “t” is determined as any of 6 to 10 during the “basic bonus game” and as any of 1 to 5 during the “history bonus game”.

Then, the number of additional games “t” determined in S55 is added to the current number of free games “T” (S56). Therefore, when the win of “BONUS 7” is made during a bonus game, the number of remaining free games is increased. For example, when the win of “BONUS 7” is made during a sixth free game in the “basic bonus game” and the number of additional games “t” is determined as 7 in S55, the number of subsequent free games is 11 (which is derived from the expression: 10−6+7). After S56, the processing proceeds to S59.

When the main CPU 41 determines that the win of “BONUS 7” has not been made (S54: NO), then the main CPU 41 determines whether symbols stopped on the pay line L make any winning combination or not (S57). When the main CPU 41 determines that any winning combination is made (S57: YES), the main CPU 41 adds, to a credit value a player is holding, a credit value that corresponds to the bet value and to a payout number of the winning combination (S58). After S58, or when the main CPU 41 determines that no winning combination has been made (S57: NO), the processing proceeds to S59.

A bet value valid at the time of shifting to a bonus game is continuously used in the bonus game. In the bonus game, credits are accumulated or paid out based on the bet value. More specifically, a bet value valid at the time when the win of “BONUS 7” was made is inherited in the “basic bonus game”. A bet value valid at the time when it was determined that five or more “BONUS 7” symbols are stored in the lottery history storage area 46 is inherited in the “history bonus game”.

In S59, the main CPU 41 reads out the number of free games “T” stored in the RAM 43, and reduces the number of free games “T” by 1. Then the reduced number of free games “T” is stored into the RAM 43 again.

Then, the main CPU 41 determines whether the number of free games “T” stored in the RAM 43 is zero or not (S60). When the main CPU 41 determines that the number of free games “T” is not zero (S60: NO), the processing returns to S52. When the main CPU 41 determines that the number of free games “T” is zero (S60: YES), the processing proceeds to S61.

In S61, the main CPU 41 resets a whole of the lottery history data that are stored in the first to fifth lottery history storage areas 46A to 46E of the lottery history storage area 46. Then, the bonus game processing ends. The processing of S61 may be performed at the time when the game is shifted to the bonus game processing (S17), that is, before S51.

As thus have been described above, in the slot machine 1 of this embodiment, every time a game is played, lottery history data is stored into the lottery history storage area 46, so that the latest five lottery history data are stored (S23). The game is shifted to the bonus game processing (S17), not only when the win of “BONUS 7” is made (S16: YES) but also when five or more “BONUS 7” symbols are stored in the lottery history storage area 46 (S18: YES). That is, a player is given an opportunity to obtain, as a privilege, not only the “basic bonus game” based on a result of the current game but also the “history bonus game” based on history data of the past several games. Therefore, even though a player missed a bonus game in the current game, he/she can still expect to obtain the “history bonus game” based on history data in the next and subsequent games. Thus, the slot machine 1 of this embodiment can present new amusement by giving a privilege based on a history, thereby motivating a player to keep playing for a long time. This is also advantageous to a game arcade in which the slot machine 1 is placed, because an operating rate increases as a player keeps playing a game on the same slot machine 1 for a longer time.

Although in the above-described embodiment one pay line L extending across in the horizontal direction is formed, this is not limitative. It may also be possible, for example, to provide several pay lines L each extending across the three display windows 10L, 10C, and 10R in a horizontal or oblique direction. In this case, pay lines L corresponding to a bet value are activated so that, when symbols stopped on any of the activated pay lines L make a winning combination, payouts corresponding to the combination may be given.

In the above-described embodiment, a coin, a bill, or valuable electronic information equivalent to them are used as a game medium. However, this is not limitative. For example, a medal, a token, electronic money, a ticket, or the like may be used as a game medium.

An excitation mode of the stepping motors 70L, 70C, and 70R is not particularly limited, and a 2 phase excitation mode, 1 phase excitation mode, or the like may be adopted for example. A DC motor may be adopted instead of the stepping motors 70L, 70C, and 70R. In a case where a DC motor is adopted, a deviation counter, a D/A converter, and a servo amplifier are sequentially connected to the sub CPU 61, and the DC motor is connected to the servo amplifier. A rotary encoder detects a rotation position of the DC motor, and supplies to the deviation counter data of the current rotation position of the DC motor.

In the above-described embodiment, firstly symbols which will be stopped are determined by lottery, and then one winning combination is determined out of several winning combinations of symbols. However, this is not limitative. For example, it may also be possible to firstly determine one of wins by lottery and then, based on the determined win, determine a combination of symbols which will be stopped.

In the above-described embodiment, data showing a symbol stopped in each of the reels 5L, 5C, and 5R is separately stored in the lottery history storage area 46. However, it may also be possible that data showing symbols determined in one lottery are stored regardless of the reels 5L, 5C, and 5R.

In the above-described embodiment, all the symbols stopped on the reels 5L, 5C, and 5R are, as lottery history data, stored in the lottery history storage area 46 for every one game. However, it may be possible to store the number of particular symbols such as the “BONUS 7” symbols stopped for every one game.

In the above-described embodiment, the latest five lottery history data is stored in the lottery history storage area 46, but this is not limitative. For example, lottery history data in the last one game alone may be stored, or lottery history data in the latest ten games may be stored.

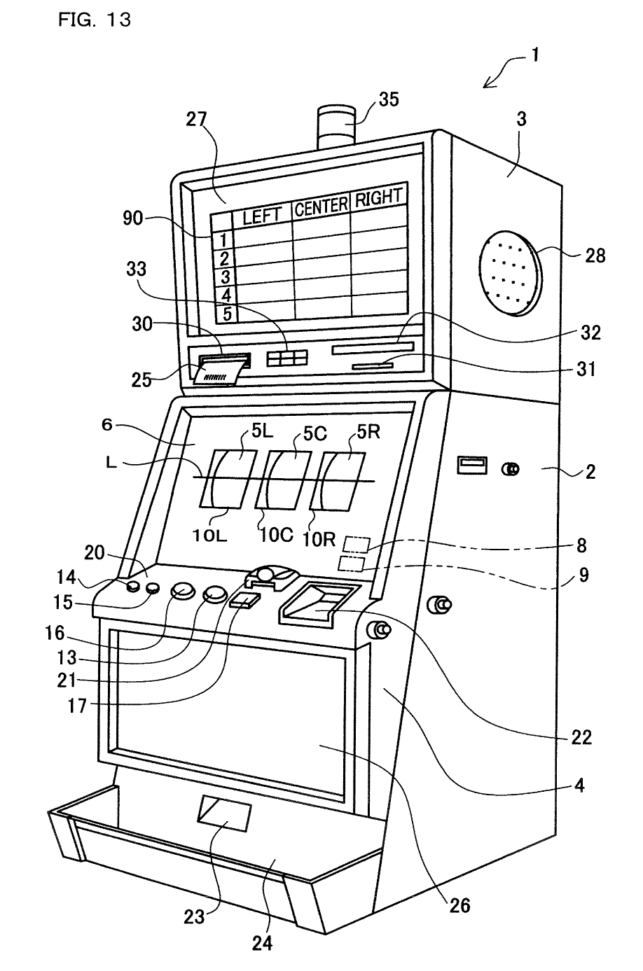

A notification unit that notifies a player of lottery history data may be provided. For example, as shown in FIG. 13, a history data indicator 90 may be formed on the upper display panel 27, so that the history data indicator 90 indicates lottery history data to thereby notify a player of the lottery history data. Alternatively, a history data indicator 90 may be formed on the lower display panel 6 in order to notify a player of the data. This allows a player to more enjoy playing a game on the slot machine 1, because he/she can surely understand that there is a possibility of obtaining a history bonus game.

In the above-described embodiment, a game is shifted to the “basic bonus game” when the win of “BONUS 7” is made, while a game is shifted to the “history bonus game” when five or more “BONUS 7” symbols are stored in the lottery history storage area 46. However, a condition for shifting to the bonus game is not limited to this. For example, it may be possible that a game is shifted to the “history bonus game” on a condition that at least one “BONUS 7” symbol is stopped on every reel 5L, 5C, 5R throughout several lottery histories.

In the above-described embodiment, a predetermined number of free games can be played in a bonus game. However, a bonus game is not limited thereto, as long as it is more advantageous to a player than the base game is. Advantageousness to a player means, for example, that the number of game media acquirable becomes larger as compared in the base game, that a possibility of acquiring a game medium becomes higher as compared with in the base game, the number of game media spent becomes smaller as compared with in the base game, or the like. A selective bonus game, in which a player selects any of options displayed on the lower display panel 6 in correspondence with the respective payout number, may be adopted as the bonus game, for example.

In the above-described embodiment, a privilege given based on a result of a current game is a “basic bonus game” and a privilege given based on lottery history data stored in the lottery history storage area 46 is a “history bonus game”. However, this is not limitative. For example, the privilege may be in the form of a credit or a bonus game different from the one employed in the above-described embodiment, e.g., the selective bonus game.

The “basic bonus game” and the “history bonus game” in the above-described embodiment are bonus games of the same type, and they differ only in the number of free games playable. However, different types of privileges may be given in the “basic bonus game” and in the “history bonus game”, respectively. For example, it may be possible that a free game can be played in the “basic bonus game” whereas a “selective bonus game” can be played in the “history bonus game”. Alternatively, it may be possible that a game is shifted to a bonus game when the “basic bonus game” is obtained whereas a credit is given when the “history bonus game” is obtained. Alternatively, it may be possible that the identical privileges are given in the “basic bonus game” and in the “history bonus game”, respectively. For example, the number of free games “T” playable in the “history bonus game” may be ten, which is the same as the number of free games playable in the “basic bonus game”.

The slot machine 1 of the above-described embodiment is a mechanical slot machine which variably displays symbols by use of the reels 5L, 5C, and 5R. However, a so-called video slot machine, which variably displays symbols by use of a display unit such as a liquid crystal display, may be adopted. The number of reels is not limited to three.

The present invention can be applied not only to the slot machine, but also to any of gaming machines other than the slot machine.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising:
variable display portions in which a plurality of symbols are variably displayed;
a lottery unit that holds a lottery for determining which symbols will be stopped in the variable display portions; and
a privilege giving unit that gives a player a privilege,
wherein:
the gaming machine further comprises a storage unit in which a history data item that indicates symbols stopped in the past is stored; and
the privilege giving unit gives a player a privilege based on symbols determined in a lottery by the lottery unit and on the history data item.

2. The gaming machine according to claim 1, wherein the machine gives a player any one of a first privilege which is based on symbols determined in a lottery by the lottery unit and a second privilege which is based on both of symbols determined in a lottery by the lottery unit and the history data item.
